(19) United States
(12) Patent Application Publication
(10) Pub. No.: US 2004/0131181 A1
(43) Pub. Date: Jul. 8, 2004

(54) Method and apparatus for encrypting content

(76) Inventor: Steven Charles Rhoads, Indianapolis, IN (US)

Correspondence Address: Joseph S Tripoli, Thomson Licensing Inc, PO Box 5312, Princeton, NJ, 08543-5312, US

(21) Appl. No.: 10/473,992

(22) PCT Filed: Apr. 3, 2002
(86) PCT No.: PCT/US02/10691

(51) Int. Cl. H04K 1/04

(52) U.S. Cl. 380/37

(57) ABSTRACT

A method for encrypting content, said method comprising encrypting a first plurality of separate blocks of content to obtain a second plurality of blocks of once-encrypted content, exchangin at elast a portion of the content stored in a first set of blocks of the second plurality of blocks of once-encrypted content with at least a portion of the content stored in a second set of blocks of the second plurality of blocks of once-encrypted content to generate a third plurality of blocks of once-encrypted content, and encrypting the third plurality of blocks of encrypted content to generate a fourth plurality of blocks of twice-encrypted content.

### FIELD OF THE INVENTION

This present invention relates to encrypting techniques for encrypting content.

### BACKGROUND OF THE INVENTION

Presently, there are many types of conventional encryption algorithms for encrypting and protecting content (e.g., text, data, audio content, video content, audio/visual content, etc.). However, most of these conventional algorithms have not been proven to be completely secure. These conventional encryption algorithms are often presumed secure due to the fact very few individuals, if any, have been able to break them and access the encrypted data. For many conventional algorithms there are cryptanalysis techniques which may be employed to determine an encryption key if the encrypted content is a known parameter.

One of the attributes that makes conventional encryption techniques susceptible to cryptanalysis is the fact that typically only one block of the content is encrypted at a time. Typically, the blocks are 32, 64 or 128 bits in length. Even using encryption techniques such as Cipher Block Chaining (CBC) does not prevent pirates from breaking the code using known cryptanalysis techniques.

Thus, there is presently a need for an encryption method which is less susceptible to cryptanalysis.

### SUMMARY OF THE INVENTION

The present invention is a method for encrypting content, by encrypting a first plurality of separate blocks of content to obtain a second plurality of blocks of once-encrypted content, exchanging at least a portion of the content stored in a first set of blocks of the second plurality of blocks of once-encrypted content with at least a portion of the content stored in a second set of blocks of the second plurality of blocks of once-encrypted content to generate a third plurality of blocks of once-encrypted content, and encrypting the third plurality of blocks of encrypted content to generate a fourth plurality of blocks of twice-encrypted content.

The present invention also comprises a computer readable medium having embodied thereon a computer program for processing by a machine. The computer program including a first code segment for encrypting a first plurality of separate blocks of content to obtain a second plurality of blocks of once-encrypted content, a second code segment for exchanging at least a portion of the content stored in a first set of blocks of the second plurality of blocks of once-encrypted content with at least a portion of the content stored in a second set of blocks of the second plurality of blocks of once-encrypted content to generate a third plurality of blocks of once-encrypted content, and a third code segment for encrypting the third plurality of blocks of encrypted content to generate a fourth plurality of blocks of twice-encrypted content.

Further, the present invention comprises a computer data signal embodied in a carrier wave including a first code segment for encrypting a first plurality of separate blocks of content to obtain a second plurality of blocks of once-encrypted content, a second code segment for exchanging at least a portion of the content stored in a first set of blocks of the second plurality of blocks of once-encrypted content with at least a portion of the content stored in a second set of blocks of the second plurality of blocks of once-encrypted content to generate a third plurality of blocks of once-encrypted content, and a third code segment for encrypting the third plurality of blocks of encrypted content to generate a fourth plurality of blocks of twice-encrypted content.

The present invention also comprises a signal transmission system including a transmitter, said transmitter encrypting a first plurality of separate blocks of content to obtain a second plurality of blocks of once-encrypted content, exchanging at least a portion of the content stored in a first set of blocks of the second plurality of blocks of once-encrypted content with at least a portion of the content stored in a second set of blocks of the second plurality of blocks of once-encrypted content to generate a third plurality of blocks of once-encrypted content, and encrypting the third plurality of blocks of encrypted content to generate a fourth plurality of blocks of twice-encrypted content before transmitting the content, and a receiver for receiving and decrypting the transmitted encrypted content.

Additionally, the present invention comprises a transmitter including a device for encrypting a first plurality of separate blocks of content to obtain a second plurality of blocks of once-encrypted content, exchanging at least a portion of the content stored in a first set of blocks of the second plurality of blocks of once-encrypted content with at least a portion of the content stored in a second set of blocks of the second plurality of blocks of once-encrypted content to generate a third plurality of blocks of once-encrypted content, and encrypting the third plurality of blocks of encrypted content to generate a fourth plurality of blocks of twice-encrypted content.

Further, the present invention comprises a method for decrypting content, said method including decrypting a first plurality of blocks of twice-encrypted content to generate a second plurality of blocks of once-encrypted content, exchanging at least a portion of the content stored in a first set of blocks of the second plurality of blocks of once-encrypted content with at least a portion of the content stored in a second set of blocks of the second plurality of blocks of once-encrypted content to generate a third plurality of blocks of once-encrypted content, and decrypting the third plurality of blocks of once-encrypted content to generate a fourth plurality of blocks of unencrypted content.

### BRIEF DESCRIPTION OF THE DRAWINGS

FIG. 1 is flow diagram showing a method according to a first exemplary embodiment of the present invention.

FIG. 2 is a block diagram showing a transmission system according to a first exemplary embodiment of the present invention.

### DETAILED DESCRIPTION

The present invention is a method for encrypting content that is less susceptible to cryptanalysis than conventional encryption methods. In order to prevent breaking of the encryption code by cryptanalysis, the present inventors have discovered that it is desirable to encrypt the entire content such that every bit of the encrypted content is dependent upon every bit of the unencrypted content, and vice versa In particular, the present invention is a method for breaking up unencrypted content into a first series of blocks, encrypting the content, ‘swapping’ respective one of the first series of blocks with one another, and encrypting the content a second time.

Cipher Block Chaining (CBC) is one encryption method for making encrypted content dependent on all of the previous unencrypted bits of the content. However, CBC does not make the encrypted content dependent on future unencrypted bits of the content. For example, take unencrypted content blocks A1, B1 and C1 which are encrypted using CBC encryption. First, block A1 is encrypted to generate encrypted block A2. In the CBC methodology, this first encrypted block A2 is used in the encryption of all blocks which follow (e.g., B1, C1). Thus, all unencrypted blocks which follow the first block are dependent upon the first block for encryption. However, none of the unencrypted blocks (e.g., A1, B1, C1) are dependent upon future blocks for encryption. This feature of CBC makes cryptanalysis of CBC encrypted content easier. CBC also does not prevent a pirate from breaking the code one block at a time using cryptanalysis techniques.

The present invention is embodied in a ‘loop through’ method for encrypting content. The ‘loop through’ method causes the encryption to loop through itself causing every bit of the encrypted content to be dependent on every bit of the unencrypted content.

Before encrypting content, a random seed number is placed at a predetermined location, such as at the beginning of the content. This makes the encrypted content different even if the same content is encrypted twice. Next, the content is encrypted using a block cipher (e.g., DES, AES, etc.). The block cipher is preferably operated in the CBC mode. The CBC mode requires that before a block is encrypted it is exclusive ORed with the encrypted content of the previous block. For decryption, after each block is decrypted it is exclusive ORed with the previous encrypted block.

Next, the first thirty-two (32) bits of every sixty-four (64) bit block are swapped with each other. Thus, for two (2) 64 bit blocks, the first 32 bits of the first block are swapped with the first 32 bits of the second block. For schemes which involve more than 2 blocks, the first 32 bits of each block are swapped with first 32 bits of the block which is the same distance from the middle of the block set. For example, for four (4) 64 bit blocks, the first 32 bits of the first block are swapped with the first 32 bits of the fourth block, and the first 32 bits of the second block are swapped with the first 32 bits of the third block. For six (6) 64 bit bocks, the first 32 bits of the first block are swapped with the first 32 bits of the sixth block, the first 32 bits of the second block are swapped with the first 32 bits of the fifth block, and the first 32 bits of the third block are swapped with the first 32 bits of the fourth block. It will be noted by those skilled in the art that, for 128 bit block encryption, 64 bit blocks may be used for loop through encryption (as opposed to 32 bit blocks). Once the blocks of content have been ‘swapped’, the content blocks are encrypted again using the same key in CBC mode. In schemes where there is an uneven number of blocks (e.g., 3, 5, 7, etc.), the middle block will be swapped with itself, thereby resulting in no overall change in that block.

The above process causes the content to be looped through itself, thus making every bit of the encrypted content dependent upon every bit of the original unencrypted content, and vice versa.

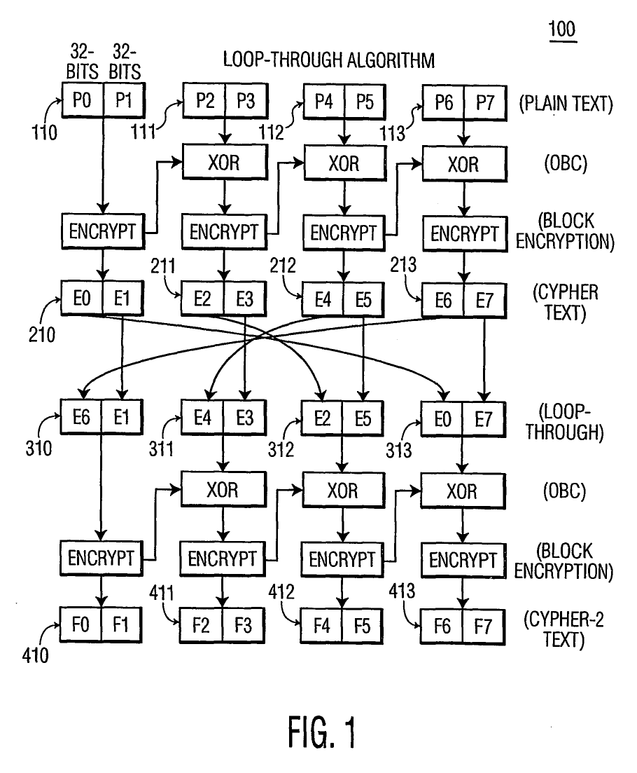

FIG. 1 shows a flow chart for a loop through encryption method 100 for encrypting content. The method begins with a first plurality of blocks 110-113 of unencrypted content, each containing 64-bit blocks. Although these blocks are shown as 64 bit blocks in FIG. 1, it will be appreciated by those skilled in the art that the blocks may be of various sizes (e.g., 128 bit, etc.) without departing from the scope of the present invention. Each 64 bit block is comprised of two separate 32 bit blocks. For example, 64-bit block 110 includes two 32-bit blocks designated as P0 and P1, 64-bit block 111 includes two 32-bit blocks designated as P2 and P3, etc. As will be noted by those skilled in the art, there should be sufficient number of blocks to accommodate the entire unencrypted message to be encrypted.

As mentioned above, these unencrypted blocks 110-113 are encrypted using a CBC mode block cipher. In the CBC mode, the first unencrypted block (e.g., block 110) in the sequence of blocks 110, 111, 112, 113 is encrypted to create a first encrypted block 210. For each following unencrypted block, the result of the encryption of the previous block is exclusive ORed (XOR) with the block before encryption. For example, encrypted block 210 (including 32 bit encrypted blocks E0, E1) derived from unencrypted block 110 is XORed with unencrypted block 111 to form an XOR block for encryption. Once the block is encrypted, encrypted block 211 (including 32 bit encrypted blocks E2, E3) is generated. Similarly, encrypted block 211 is exclusive ORed with unencrypted block 112 before the block is encrypted to generate encrypted block 212 (including 32 bit encrypted blocks E4, E5), and encrypted block 212 is exclusive ORed with unencrypted block 113 before the block is encrypted to generate encrypted block 213 (including 32 bit encrypted blocks E6, E7).

The result of the CBC block mode encryption is a second plurality of once-encrypted blocks 210-213 (including 32 bit encrypted blocks E0-E7). It will be noted that each of the once-encrypted blocks 211-213 (E2-E7) are all dependent upon the preceding block due to the exclusive OR function.

Next, a ‘loop through’ of the once-encrypted blocks 210-213 (E0-E7) is performed. By ‘loop through’, it is meant that the first 32 bits (e.g., E0) of each 64 bit once-encrypted block (e.g., 210) are exchanged with the first 32 bits (e.g., E6) of the corresponding 64 bit once-encrypted block (e.g., 213) on the opposite side of the encrypted block array. For example, 32 bit block E0 is exchanged with the 32 bit block E6, and 32 bit block E2 is exchanged with 32 bit block E4. After the exchange or ‘loop through’, the 32 bit blocks E0-E7 are ‘out of order’ so to speak, resulting in a third plurality of blocks 310-313.

Next, the once-encrypted and rearranged blocks 310-313 are subjected to the same CBC block cipher as described above with respect to blocks 111-113. In particular, the first once-encrypted encrypted block (e.g., block 310) in the sequence is encrypted again to create a first twice-encrypted block 410. For each following once-encrypted block, the first twice-encrypted block 410 is exclusive ORed with the next (second) once-encrypted block (e.g., block 311) in the sequence before the second encryption process. In the present case, block 310 is first once-encrypted to generate twice-encrypted block 410 (including 32 bit encrypted blocks F0, F1). Then, the twice-encrypted block 410 is exclusive ORed with once-encrypted block 311 before the block is encrypted again to generate twice-encrypted block 411 (including 32 bit encrypted blocks F2, F3). Similarly, twice-encrypted block 411 is exclusive ORed with once-encrypted block 312 before the block is again encrypted to generate twice-encrypted block 412 (including 32 bit encrypted blocks F4, F5), and twice-encrypted block 412 is exclusive ORed with once-encrypted block 313 before the block is encrypted again to generate twice-encrypted block 413 (including 32 bit encrypted blocks F6, F7). The above-described process produces a fourth plurality of blocks 410-413 which are twice-encrypted and once rearranged (‘swapped’).

It will be noted that the rearranged and twice-encrypted blocks of content 410-413 will be extremely difficult to decipher using conventional cryptanalysis techniques. In order to decipher the message (e.g., blocks 110-113)), the entire message would have to be deciphered as a single block, since every bit of the encrypted content is dependent upon every bit of the unencrypted content. For larger messages, the time and memory necessary to try random encryption keys increases linearly with the size of the message, thereby making cryptanalysis extremely difficult.

For decryption, the above process may be performed in reverse. For example, each of the blocks 410-413 are first unencrypted and then exclusive ORed with the previous block in the sequence to produce the blocks 310-313. Then, the ‘loop through’ operation is performed in reverse to generate the blocks 210-213. Finally, each of the blocks 210-213 are unencrypted and exclusive ORed with the previous block in the sequence to produce the original unencrypted blocks 110-113.

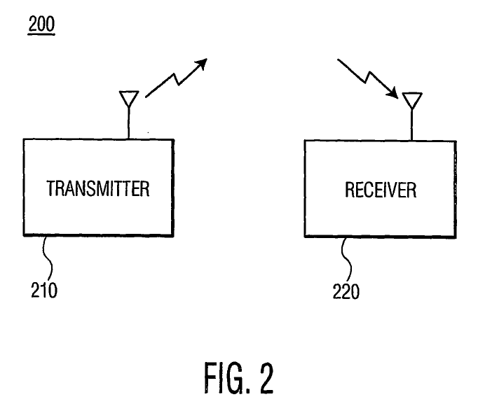

FIG. 2 shows a transmission system 200 according to an exemplary embodiment of the invention. The system 200 includes a transmitter 210 and a receiver 220. The transmitter 210 preferably includes hardware or software for implementing the above-described encryption method. The transmitter 210 also preferably includes hardware or software for transmitting such encrypted content to the receiver 220. Similarly, the receiver 220 includes hardware or software for receiving and decrypting the content forwarded by the transmitter 210. The receiver 220 may use the above-described decryption process for decrypting the received content. Although the connection between the transmitter 210 and the receiver 220 is shown in FIG. 2 as being a wireless connection, it will be noted by those skilled in the art that wired connections may also be used without departing from the scope of the present invention.

The transmission system 200 may comprise many different types of transmission systems. For example, the transmission system 200 may comprise a conditional access (CA) system where the transmitter 210 comprises a satellite or cable transmission station and the receiver 220 comprises a set top box (STB) or other equivalent receiving unit.

The present invention may be embodied in the form of computer-implemented processes and apparatus for practicing those processes. The present invention may also be embodied in the form of computer program code embodied in tangible media, such as floppy diskettes, read only memories (ROMs), CD-ROMs, hard drives, high density disk, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

Although the invention has been described in terms of exemplary embodiments, it is not limited thereto. Rather, the appended claims should be construed broadly, to include other variants and embodiments of the invention which may be made by those skilled in the art without departing from the scope and range of equivalents of the invention.

1. A method for encrypting content, said method comprising:
encrypting a first plurality of separate blocks of content to obtain a second plurality of blocks of once-encrypted content;
exchanging at least a portion of the content stored in a first set of blocks of the second plurality of blocks of once-encrypted content with at least a portion of the content stored in a second set of blocks of the second plurality of blocks of once-encrypted content to generate a third plurality of blocks of once-encrypted content; and,
encrypting the third plurality of blocks of encrypted content to generate a fourth plurality of blocks of twice-encrypted content.

2. The method of claim 1, comprising the further step of:
inserting a random number at a predetermined position within the first plurality of separate blocks of content before encrypting the separate blocks of content.

3. The method of claim 1, wherein the step of encrypting a first plurality of separate blocks of content comprises encrypting the blocks using block encryption.

4. The method of claim 1, wherein the step of encrypting the third plurality of blocks comprises encrypting the blocks using block encryption.

5. The method of claim 1, wherein each of the separate blocks of content in the first plurality comprise 32-bit blocks.

6. The method of claim 1, wherein each of the separate blocks of content in the first plurality comprise 64-bit blocks.

7. The method of claim 1, wherein each of the separate blocks of content in the first plurality comprise 128-bit blocks.

8. The method of claim 1, wherein the step of encrypting a first plurality of separate blocks of content comprises:
encrypting at least one first block of the content;
performing a logical operation between the at least one first encrypted block of content and at least one second block of the content before encrypting the at least one second block of content; and,
encrypting the at least one second block of content.

9. The method of claim 8, wherein the logical operation comprises an exclusive OR function.

10. The method of claim 8, comprising the further steps of:
performing a logical operation between the at least one second encrypted block of content and at least one third block of the content before encrypting the at least one third block of content; and,
encrypting the at least one third block of content.

11. The method of claim 10, wherein the logical operation comprises an exclusive OR function.

12. The method of claim 1, wherein the step of exchanging the encrypted content comprises:
exchanging at least a portion of the encrypted content stored in a first block of the second plurality of blocks with at least a portion of the encrypted content stored in a second block of the second plurality of blocks which is the same distance from a center of the second plurality of blocks as the first block.

13. The method of claim 12, wherein the step of exchanging the encrypted content comprises the further step of:
exchanging at least a portion of the encrypted content stored in each block following the first block of the second plurality of blocks with at least a portion of the encrypted content stored in respective blocks which are the same distance from a center of the second plurality of blocks.

14. The method of claim 1, wherein the step of encrypting the third plurality of blocks of encrypted content comprises:
encrypting at least one first block of the encrypted content;
performing a logical operation between the at least one first encrypted block of content and at least one second block of the content before encrypting the at least one second block of content; and,
encrypting the at least one second block of content.

15. A computer readable medium having embodied thereon a computer program for processing by a machine, the computer program comprising:
a first code segment for encrypting a first plurality of separate blocks of content to obtain a second plurality of blocks of once-encrypted content;
a second code segment for exchanging at least a portion of the content stored in a first set of blocks of the second plurality of blocks of once-encrypted content with at least a portion of the content stored in a second set of blocks of the second plurality of blocks of once-encrypted content to generate a third plurality of blocks of once-encrypted content; and,
a third code segment for encrypting the third plurality of blocks of encrypted content to generate a fourth plurality of blocks of twice-encrypted content.

16. A computer data signal embodied in a carrier wave comprising:
a first code segment for encrypting a first plurality of separate blocks of content to obtain a second plurality of blocks of once-encrypted content;
a second code segment for exchanging at least a portion of the content stored in a first set of blocks of the second plurality of blocks of once-encrypted content with at least a portion of the content stored in a second set of blocks of the second plurality of blocks of once-encrypted content to generate a third plurality of blocks of once-encrypted content; and,
a third code segment for encrypting the third plurality of blocks of encrypted content to generate a fourth plurality of blocks of twice-encrypted content.

17. A signal transmission system comprising:
a transmitter, said transmitter encrypting a first plurality of separate blocks of content to obtain a second plurality of blocks of once-encrypted content, exchanging at least a portion of the content stored in a first set of blocks of the second plurality of blocks of once-encrypted content with at least a portion of the content stored in a second set of blocks of the second plurality of blocks of once-encrypted content to generate a third plurality of blocks of once-encrypted content, and encrypting the third plurality of blocks of encrypted content to generate a fourth plurality of blocks of twice-encrypted content before transmitting the content; and,
a receiver for receiving and decrypting the transmitted encrypted content.

18. A transmitter comprising:
a device for encrypting a first plurality of separate blocks of content to obtain a second plurality of blocks of once-encrypted content, exchanging at least a portion of the content stored in a first set of blocks of the second plurality of blocks of once-encrypted content with at least a portion of the content stored in a second set of blocks of the second plurality of blocks of once-encrypted content to generate a third plurality of blocks of once-encrypted content, and encrypting the third plurality of blocks of encrypted content to generate a fourth plurality of blocks of twice-encrypted content.

19. A method for decrypting content, said method comprising:
decrypting a first plurality of blocks of twice-encrypted content to generate a second plurality of blocks of once-encrypted content;
exchanging at least a portion of the content stored in a first set of blocks of the second plurality of blocks of once-encrypted content with at least a portion of the content stored in a second set of blocks of the second plurality of blocks of once-encrypted content to generate a third plurality of blocks of once-encrypted content; and,
decrypting the third plurality of blocks of once-encrypted content to generate a fourth plurality of blocks of unencrypted content.
